(19) United States
(12) Patent Application Publication
(10) Pub. No.: US 2003/0233557 A1
(43) Pub. Date: Dec. 18, 2003

(54) Electronic signature verification method and apparatus

(76) Inventor: Thomas Guthrie Zimmerman, Cupertino, CA (US)

Correspondence Address: DANIEL E. JOHNSON, IBM CORPORATION, ALMADEN RESEARCH CENTER, INTELLECTUAL PROPERTY LAW DEPT. C4TA/J2B, 650 HARRY ROAD, SAN JOSE, CA, 95120-6099, US

(21) Appl. No.: 10/173,002

(22) Filed: Jun. 13, 2002

(51) Int. Cl. H04L 9/32

(52) U.S. Cl. 713/186; 713/202

(57) ABSTRACT

A computer system is used for tokenless identification, verification and authorization of a person. An enrollment process is used for registering the person, who at the time of registration gives a phone number and/or name for identification, as well as at least one reference handwritten signature for use in a verification template. Services to which the person is entitled to receive may also be established at the time of registration. At the time a transaction is made, the person is identified by providing the phone number and/or name so that the stored handwritten signature can be retrieved, the person's identity is verified by providing a handwritten signature that is matched with the retrieved (reference) handwritten signature, and the person is authorized to conduct a transaction. In this way, a transaction may be conducted without the person using any portable man-made memory devices such as smart cards or swipe cards, or being required to remember any PIN or account number.

### TECHNICAL FIELD

The invention is in the field of verifying the identity of an individual. More particularly, the invention relates to a method of doing this through the use of a signature.

### BACKGROUND

Significant progress has been made in developing systems that reliably establish the identity of a person. Recently, systems have been designed that measure a biometric attribute of an individual (such as patterns in the iris, retina, fingerprint, voice, signature, hands, and face) and then match the measured attribute with an authentic “ground truth” reference, known as the biometric template. Such systems have the advantage of measuring attributes that are inherent in an individual, i.e., attributes that are always with the person and that are not likely to be altered or compromised.

In a typical biometric system, an individual is enrolled by taking one or more biometric samples that form his or her “biometric template”. This template is then assigned a unique identifier (typically a number), which then serves as an index (address) when retrieving that individual's biometric template from a database of templates. The database can contain other information about the individual, such as financial account information, as well as references to other databases. These databases can be small and contain, for example, at most dozens of entries corresponding to the employees of a store; or they may be large, containing hundreds of thousands of entries for patients in a hospital, or even extremely large, containing millions of entries for bank credit card members or customers of a large retail chain.

Once an individual has been enrolled, he or she can be identified, verified, and authenticated when making a business transaction. Identification refers to the process of matching a collected biometric sample to one of many biometric templates (i.e., 1 to N matching). Verification refers to matching a collected biometric sample to one particular template (i.e., 1 to 1 matching). Authentication confers access and services to an individual that has been verified. Biometric identification, verification and authentication systems may be used to allow, deny, or restrict the access and delivery of services in a wide range of applications and domains, including: financial transactions; gaining physical access to a room, facility or club; gaining electronic access to data, documents, computing capability, or media; and participatory privileges and rights in driving, voting, visiting, traveling and working.

In practice, imperfect sampling of a biometric feature can result in an error in the sample-to-template matching, which can be categorized either as a false accept (also known as a false positive) or as a false reject (also known as a false negative). A false accept (FA) arises when a collected biometric sample is erroneously matched to a biometric template. A false reject (FR), on the other hand, occurs when a collected biometric sample fails to be matched to the proper biometric template. Biometric matching algorithms may be adjusted to trade off FA against FR, or vice versa, in order to meet the needs of the application. (Biometric matching algorithms are taught, for example, in U.S. Pat. No. 5,710,916 to Barbara et al. titled “Method and apparatus for similarity matching of handwritten data objects,”; U.S. Pat. No. 4,646,351 to Abso et al. titled “Method and apparatus for dynamic signature verification”; and U.S. Pat. 3,983,535 to Herbst et al., “Signature verification method and apparatus”. These patents, as well as all other U.S. patents, co-pending applications, and published patent applications cited herein are hereby incorporated by reference in their entirety.) Applications involving frequent small purchases, such as fast food or convenience store purchases, can more easily tolerate greater FA in order to gain greater FR, so that fewer valid customers are rejected, while higher price transactions like appliances and electronics are better suited for minimizing the losses from FA.

Biometric identification is more prone to error than is biometric verification. For example, if there is a 1 percent chance of a false accept and the database has one million biometric templates, a collected sample will produce on average 10,000 false accepts (one million times one percent) in the absence of any verification procedure, while a collected sample submitted with an identifier for verification will produce on average 0.01 instances of false accepts (one times one percent). It is therefore preferred to reduce an identification problem to the more tractable verification problem by providing a means of identifying the individual.

A physical device, known as a token, may be used to identify the individual Credit cards, ATM cards, smart cards, radio frequency identification (RFID) tags, and bar codes are all examples of tokens. A biometric system may be designed to use the identification information contained in the token to index and retrieve the biometric template of the individual, and then perform a verification test on the collected biometric sample.

For many years significant efforts have been made to develop an electronic system that would reliably establish the identity of a person to enable financial transactions. Systems used for retail applications typically use a magnetic strip card as a token. However, since a card can be stolen, methods have been developed to verify the identity of the person using the card. ATM cards typically require the user to enter a personal identification number (PIN) or secret code using a numeric keypad. Since for security reasons the PIN is preferably not written down, it should be memorized by the user, and for this reason it is typically kept short. The identification information stored on the magnetic stripe of the ATM card is used to index the person's reference PIN number, which is usually stored on a remote secure server. If the retrieved reference PIN number is the same as that offered by the user, and the account is sound, the transaction is allowed. The card owner must nevertheless take precautions to prevent a potential thief from viewing the key strokes corresponding to the PIN number. In addition, since it is a common practice for an individual to use the same PIN number for multiple accounts, a breach in one system potentially affects the security of others.

A credit card typically uses a signature for verification. The signature template (the authentic “ground truth” reference) is written on the card by the owner when the card is received. This poses several problems, however: it provides a potential forger a signature specimen, the signature offered by the customer is typically checked by a cashier untrained in the skills of signature forensics, and the signature template can be tampered with and a new signature entered. Furthermore, the card may be intercepted before it reaches the intended recipient, in which case another signature can be written on the card.

A smart card is an example of a more sophisticated token, which combines electronic memory and processing capability to enable the storage of encrypted information. A smart card can contain a person's identification and verification information. For example, the PIN number can be contained in the card and verified locally. A smart card is designed to make it very difficult for someone who gains possession of the card to determine the card's contents. However, a potential thief might still ascertain the PIN number by observing the card's owner entered keystrokes, thereby compromising any other uses of the PIN number.

U.S. Pat. No. 6,219,439 to Burger et al. titled “Biometric authentication system” teaches a biometric authentication system that embeds a biometric template into a smart card, enabling local verification of an individual's biometric sample. Although this makes it very difficult for any thief to use the card, the user must still carry the card to use it, so that misplacement, loss or theft would prevent its use.

One additional disadvantage of the foregoing token methods is that an entry station is required for electronically reading the identification information contained on or in the card. The cost of these stations is significant when deployed in large numbers. For example, a large retail chain may require tens of thousands of such stations.

A tokenless method of identification commonly used involves a user typing a user name and a password. In this case, the user name is the identifier, thereby reducing the problem to one of verification. The password is a secret known to the user that verifies his or her identity. This method generally involves an alphanumeric keyboard as an entry station, with the keyboard taking up considerable space, a valuable and limited resource in many settings such retail stores, fast food restaurants, and banks. Further, passwords must be memorized and guarded during use.

U.S. Pat. No. 6,366,682 to Hoffman et al. titled “Tokenless electronic transaction system” teaches a tokenless electronic transaction system in which a PIN is keyed in and used for identification, and a biometric sample (e.g., a fingerprint) is used for verification. As in other systems, the user must guard against revealing the PIN number to anyone else if this number is used for verification in other financial transaction systems (e.g., at an ATM). In addition, it should be noted that there is significant public resistance to being fingerprinted, due to the use of fingerprints in registering and tracking criminals. Also, recent work reported by T. Matsumoto et al. (see “Impact of Artificial Gummy Fingers on Fingerprint Systems,” Proceedings of SPIE Vol. #4677, Optical Security and Counterfeit Deterrence Techniques IV, 2002) demonstrates how simple methods using gelatin molds may be used to create fingerprint facsimiles of sufficiently good quality to fool most fingerprint readers.

Identity verification by means of a written signature has long been in use: An ink signature on paper has been, and continues to be, commonplace in financial transactions. Contracts, credit card slips, and checks become legally binding once signed. In the US, electronic signatures may be used to authorize a business transaction. However, most signatures are recorded as a static representation. Thus, a sample signature can give a forger the opportunity to practice and reproduce the appearance of a legitimate signature.

Dynamic signature verification (also known as on-line signature verification), on the other hand, measures various time-varying physical characteristics of handwriting including pen tip pressures, velocities, accelerations, and directions of writing—features that are not disclosed by a static image of the signature. Although two signatures may appear the same on paper, the time-varying action of the hand on the pen required to create the written image can be dramatically different. By recording and comparing these dynamic artifacts of handwriting, the authenticity of a signature may be verified, and the success rate of any potential forger is greatly diminished. Methods to record the physical characteristics of handwriting are taught in U.S. Pat. No. 5,561,282 to Price et al. titled “Portable signature capture pad”. Methods to match a customer's signature (that is to be verified) with a reference signature are taught in U.S. Pat. No. 6,160,914 to Muroya titled “Handwritten character verification method and apparatus therefor”; U.S. Pat. No. 6,339,655 to Aharonson et al. titled “Handwriting recognition system using substroke analysis”; and U.S. Pat. No. 4,901,358 to Bechet et al. titled “Method of comparing a handwriting with a reference writing”.

In order to avoid confusion in terminology, it is helpful to point out the difference between two terms that appear to be similar but in fact have very different meanings. A digitized signature is a digital representation of a person's handwriting (see, for example, U.S. Pat. No. 4,845,478 to Taguchi et al. titled “Coordinate input device with display”), and is a subject of the present invention. On the other hand, a digital signature is a mathematical operation performed on a digital message to insure the authenticity of the message and sender. For example, U.S. Pat. No. 6,081,610 to Dwork et al. titled “System and method for verifying signatures on documents” and U.S. patent application Publication Ser. No. 2001/0044896A1 to Schwartz et al. titled “Authentication technique for electronic transactions” both refer to digital signatures (mathematical operations on data) to insure authenticity, and are not concerned with digitized signatures created by recording human handwriting.

The field of dynamic signature verification has focused on a signature because it is a personalized sequence of characters that people use frequently—a signature has traits unique to the individual and is reproduced (repeatable) over time. However, any substantially repeatable handwritten sequence of characters may be used for verification. U.S. Pat. No. 6,236,740 to Lee titled “Signature verification apparatus and method utilizing relative angle measurements” teaches a dynamic signature verification system requiring both a signature and the current date. This creates a handwriting sample that effectively changes daily, preventing a “record and playback” attack. German Patent DE19844181A1 teaches handwriting verification by “signing” with a PIN number, thereby confirming the user's knowledge of the PIN number and establishing his or her ability to dynamically write the PIN number in a manner that is consistent with a recorded template.

There is still a need for a simple identification and verification system that would be readily accepted by the public.

### SUMMARY OF THE INVENTION

Preferred implementations of the invention are a method and system for tokenless identification, verification, and authorization of an individual using electronic processors. At the time of registration the individual provides at least one reference signature. When a transaction is made, the individual prints his or her phone number or name and signs his or her name on a digitizing station, such as a LCD having a position sensing digitizer (e.g., a touch screen). A character recognition process converts the handwritten phone number or name into corresponding computer characters used to index and retrieve the person's reference signature (biometric template). (Character recognition processes are discussed in U.S. Pat. No. 6,175,651 to Ikebata et al. titled “On line-character recognition method and device”; U.S. Pat. No. 6,243,493 to Brown et al. “Method and apparatus for handwriting recognition using invariant features”; and U.S. Pat. No. 6,084,985 to Dolfing et al. “Method and apparatus for on-line handwriting recognition based on feature vectors that use aggregated observations derived from time-sequential frames”.) A dynamic (or static) handwriting matching method compares the signature provided at the time of the transaction with the reference signature, and if they are sufficiently similar, authorizes a prescribed action. In a retail setting, the prescribed action might be to authorize the debiting of a checking account in the amount of the required tender.

In another implementation, an individual keys in a phone number into the digitizing station by touching the appropriate sequence of digits, referred to as soft keys. Upon acceptance of the phone number by the computer, the person signs his or her name, thereby enabling identification and verification of the individual, respectively.

One advantage of preferred implementations of the invention is the use of a person's phone number (or name) for identification, so that committing an additional PIN or code to memory, or revealing such secret codes to others, is not required. In addition, since a physical token is not used, there is no concern that it might be misplaced, lost or stolen, and there are no costs associated with printing special debit cards or the like. Using a signature has the further benefit that it is something that is familiar to the customer, since providing a signature has been the traditional method of asserting identity, binding agreements, and authorizing transactions. This is to be contrasted with providing a fingerprint, which in the mind of the public is associated with criminals, criminal activity, and invasion of privacy.

An advantage of one implementation of the invention is to accommodate the needs of a family with several members with different financial needs and one or more phone numbers. In this implementation, several people may be enrolled under one or more phone numbers, each with an individual profile that specifies the services and financial limits to which he or she is entitled.

Yet another advantage of preferred implementations of the invention is to minimize false rejections (FR) by setting the FR threshold in response to the risks associated with authorization. Thus, retail transactions of low value may allow greater FA than higher value transactions.

Preferred implementations of the inventions offer other advantages as well. For example, the security of other accounts is not breached because no PIN number is used or disclosed. The use of a dynamic signature rather than a static one makes forgery more difficult. At the same time, pen and paper can be used, preserving a traditional experience. Also, existing digitization stations and infrastructure may be used, thereby saving costs.

One aspect of the invention is a method of verifying an individual's signature as viewed from a retailer's perspective. The method includes electronically capturing an individual's signature at the time of verification, and electronically capturing from the individual at the time of verification a written identifier other than the individual's signature. The written identifier serves to identify the individual, so that the individual's captured signature can be electronically compared with a previously collected signature that is stored in a database, in which the database stores the previously collected signature with respect to an index given by the identifier. In this manner, the individual is verified as being the same person from whom the stored signature was previously collected. In a preferred method, payment for a purchase is authorized as a result of the electronic comparison, e.g., when the amount of the payment is less than a predetermined limit. In one preferred method, the written identifier is a phone number known to the individual, or alternatively, a name of the individual.

Another aspect of the invention is a method of verifying an individual's signature as viewed from a retailer's perspective. The method includes capturing the individual's signature electronically at the time of verification, and receiving, at the time of verification, input from the individual corresponding to his or her phone number, so that the individual's captured signature can be electronically verified by comparing it against a pre-collected signature that is stored in a database in which the pre-collected signature is indexed to the phone number. In a preferred method, payment for a purchase is authorized as a result of the comparing, e.g., only if the amount of the payment is less than a predetermined limit. The input can be written input or, in an alternative implementation, it may be entered using keys.

Yet another aspect of the invention is a method of verifying an individual's signature as viewed from a retailer's perspective. The method includes capturing the individual's signature electronically at the time of verification, and receiving, at the time of verification, input from the individual corresponding to one of his or her government issued identification numbers. In this manner, the individual's captured signature can be electronically verified by comparing it against a pre-collected signature that is stored in a database, in which the pre-collected signature is indexed to the individual's identification number. The government issued identification number may be selected from the group consisting of a social security number, driver's license number, passport number, green card number, or military ID number.

Another aspect of the invention is a method of verifying an individual's signature as viewed from an authenticator's perspective, e.g., a financial institution. The method includes receiving an electronically captured signature provided by the individual at the time of verification, and receiving at the time of verification an electronically captured identifier other than the individual's signature, in which the identifier serves to identify the individual and has been provided by the individual as written input at the time of verification. The method further includes identifying at least one person in a database by matching the individual's captured written identifier with an identifier in the database, in which the database identifier has been previously entered into the database and is associated with said at least one person. The method also includes electronically retrieving from the database, for each of said at least one identified person, a signature of said at least one person that has been previously collected and entered into the database, and electronically comparing the individual's captured signature with the retrieved signature to verify that the individual is the same person from whom the retrieved signature was previously collected. In a preferred method, payment for a purchase is authorized as a result of the electronic comparison. Also, payment is authorized only if the amount of the payment is less than a predetermined limit. The written input may be a phone number known to the individual, or in an alternative implementation, the name of the individual.

Yet another aspect of the invention is a method of verifying an individual's signature as viewed from an authenticator's perspective, e.g., a financial institution. The method includes receiving an electronically captured signature provided by the individual at the time of verification, and receiving, at the time of verification, input from the individual corresponding to his or her phone number. The method further includes identifying one or more persons in a database by matching the individual's phone number with a phone number in the database. The method also includes electronically retrieving from the database, for each of said one or more persons, a pre-collected signature, and electronically verifying the individual's signature by comparing it against the retrieved signature. In a preferred method, payment for a purchase is authorized as a result of the electronic comparison, e.g., payment may be authorized only if the amount of the payment is less than a predetermined limit. The input may be written input, or alternatively, the input may be entered using keys.

Another aspect of the invention is a method of verifying an individual's signature as viewed from an authenticator's perspective, e.g., a financial institution. The method includes receiving an electronically captured signature provided by the individual at the time of verification, and receiving, at the time of verification, input from the individual corresponding to one of his or her government issued identification numbers. The method further includes identifying one or more persons in a database by matching the identification number with an identification number in the database. The method also includes electronically retrieving from the database, for each of said one or more persons, a pre-collected signature, and electronically verifying the individual's signature by comparing it against the retrieved signature.

One embodiment of the invention is a digitizer unit that includes an electronic component. The electronic component includes a field designed for electronically capturing a signature and a field designed for electronically capturing written input (other than a signature) that identifies a user of the unit. The unit further includes an electronic controller in electronic communication with the component, and a housing for holding the controller and the display. The written input can be a phone number, or in another embodiment, a name. The component may include a display and a position capture element.

Yet another embodiment of the invention is a digitizer unit that includes an electronic component. The component includes a field designed for electronically capturing a signature and a field designed for electronically capturing a phone number. The device further includes an electronic controller in electronic communication with the component, and a housing for holding the controller and the display.

Still another embodiment of the invention is a digitizer unit that includes an electronic component. The component includes a field designed for electronically capturing a signature and a field designed for electronically capturing a government issued identification number. The device further includes an electronic controller in electronic communication with the component and a housing for holding the controller and the display.

In preferred implementations herein, methods of verifying an individual's signature include capturing a signature and an identifier, both of which are provided at the time of verification. By the time of verification, it is meant, for example, at the time that the transaction is conducted, e.g., in a retail setting, this may be as the customer is standing in line to make a purchase.

In other implementations, there are provided computer program products for carrying out any of the methods herein.

### BRIEF DESCRIPTION OF THE DRAWINGS

FIG. 1 is a high level block diagram of components in a system in accordance with a preferred implementation of the invention;

FIG. 2 shows a digitizer unit for collecting user input;

FIGS. 3A, 3B, 3C, and 3D show screen images of an enrollment method;

FIGS. 4A, 4B, 4C, and 4D show screen images of a customer payment method used at the time a transaction is made;

FIG. 5 shows a screen image used in an alternate customer payment method;

FIG. 6A shows a paper receipt used in another customer payment method;

FIG. 6B shows a digitizer unit to be used with a paper receipt like the one shown in FIG. 6A;

FIG. 7 is a flow chart showing steps in an enrollment process; and

FIG. 8 is a flow chart of an authorization system.

### DETAILED DESCRIPTION OF THE INVENTION

Preferred embodiments of the invention are now described with respect to the accompanying figures.

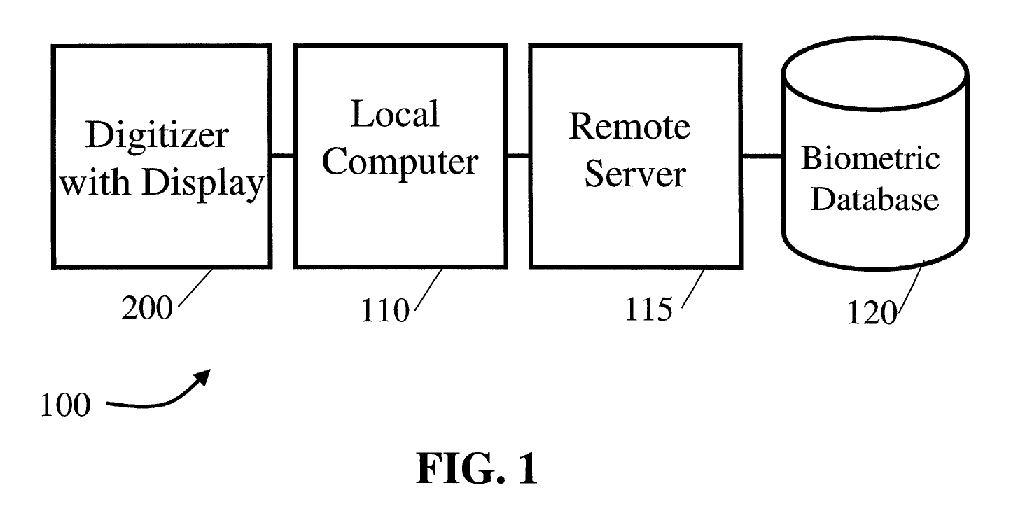

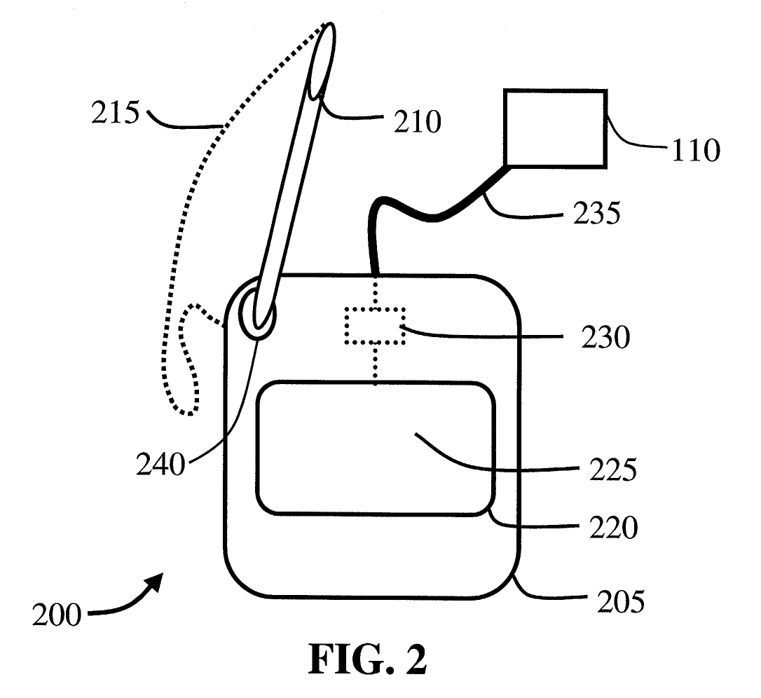

FIG. 1 is a high-level block diagram of a system 100 for identifying a person and verifying his or her identity using signature verification (preferably dynamic), e.g., to facilitate a financial transaction. A digitizer unit 200 that includes a display (see FIG. 2) is used to receive input from a person who desires to enroll in the system. Likewise, the same digitizer unit 200 (or another digitizer located at another location) may be used by the enrollee (customer) at the time a transaction is executed to verify his or her identity. If the system 100 is used by a retail chain, for example, there may be a digitizer unit 200 in each one of the checkout lanes at each store in the chain. The input provided by the person is sent from the digitizer unit 200 to a local computer 110 (located at the store, for example), and then on to a remote server 115 (that is preferably secure and may be tied to different computers 110 located at respective stores in a retail chain) that maintains or is in communication with a biometric database 120.

Examples of displays having pen or touch screen digitizers include the commercially available Hand Held Products (HHP) Transaction Team™ 1500 signature capture pad and Hypercom® ICE™ 6000 POS terminal. (See also U.S. Pat. No. 5,408,078 to Campo et al. titled “Portable point of sale terminal”; U.S. Pat. No. 4,890,096 to Taguchi et al. titled “Coordinate input device with display”; U.S. Pat. No. 4,845,478 to Taguchi et al. titled “Coordinate input device with display”; and U.S. Pat. No. 5,696,909 to Wallner titled “Virtual POS terminal”.) In retail environments the local computer 110 is typically a point-of-sale (POS) terminal, such as an electronic cash register (ECR) like that disclosed in U.S. Pat. No. 6,199,049 to Conde et al. titled “Verifiable electronic journal for a point of sale device and methods for using the same”. The remote server 115 can be operated by a financial organization that clears financial transactions, such as store credit departments, Visa, First Data, banks, and other financial institutions. An example of a database that can be used to create, maintain, search, and retrieve entries into the biometric database 120 is the database product DB2 by the IBM Corporation. A more detailed explanation of how POS terminals are interconnected with financial systems and services can be found in U.S. Pat. No. 5,144,651 to Cooper titled “Reduced time remote access method and system”; U.S. Pat. No. 5,526,409 to Conrow et al. titled “Adaptive communication system within a transaction card network”; and U.S. Pat. No. 4,972,463 to Danielson et al. titled “In-store multiple device communications unit and centralized data system utilizing same”.

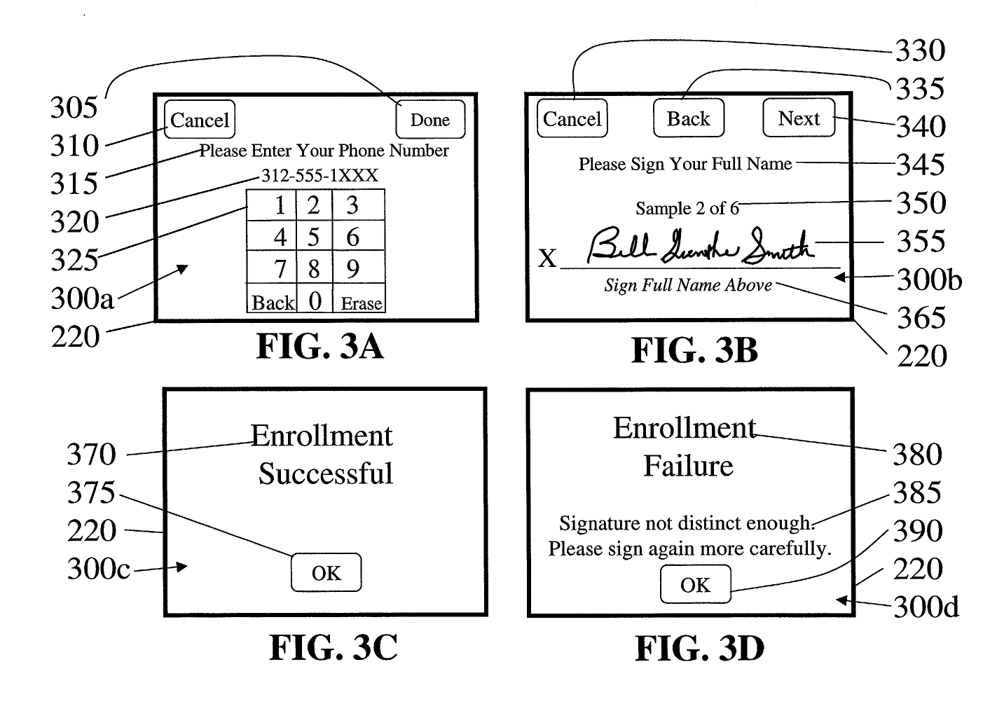

The digitizer unit 200 located at the customer station is shown in greater detail in FIG. 2. The digitzer unit 200 includes a digitizer base 205 to which a stylus 210 is connected via a tether 215, as well as an LCD display 220 covered by a digitization screen 225. When not in use, the stylus 210 can be inserted into the base 205 through a holder piece 240. The user provides input by writing with the stylus 210 on the screen 225 (or alternatively, by applying a finger to the screen 225 as suggested in FIG. 3A, for example). The screen 225 is in electrical communication with a controller 230 (e.g., a microprocessor) housed in the digitizer base 205. The controller 230 receives image information from the local computer 110 over the data link 235 and outputs images to the display 220. The controller 230 receives object (e.g., pen, stylus, finger tip) position information from the digitization screen 225 and sends the position information to the local computer 110 over the data link 235. In this manner, the local computer 110 can output images and receive written input for analysis.

The screen 225 (and the digitization surface 689 discussed below) are specific examples of position capture elements. These position capture elements may include resistive films, capacitive electrodes, magnetic coils, radio frequency antennas, membrane arrays, ultrasonic, optical, and other sensing technologies to determine the position of a stylus, pen, finger, or other object on or near the position capture element.

FIGS. 3A, 3B, 3C, and 3D show images 300a, 330b, 300c, and 300d, respectively, appearing on the display 220 and preferably stored in the controller 230, in which these images correspond to different steps in the enrollment process mentioned above. Image 300a is used to collect an enrollee's phone number, which can then be used as an identifier of the enrollee. The request message 315 (“Please Enter Your Phone Number”) communicates the purpose of the image 300a. The phone number entry status line 320 shows which numbers have been entered (represented as digits 0-9) and which have yet to be entered (designated in FIG. 3A as the “X” characters). The symbol “-” is a cue to the enrollee that all ten digits of a phone number are to be entered (corresponding to phone service in North America, namely, 3 digits for the area code plus 7 digits for the local number; the image may be tailored for countries having different requirements). Entering all ten digits is preferred in order to resolve the ambiguity that would arise if two different enrollee's had the same local number, but different area codes. The phone number can be conveniently entered on soft keys of a keypad image 325 appearing on the display 220. Additional buttons in the keypad image 325 are displayed that provide additional control: “cancel” 310 to cancel the enrollment process, “done” 305 to indicate that the phone number entry is complete, “back” to delete the previously entered number, and “erase” to delete all numerical entries up to that point.

Once a phone number has been entered, the enrollee is prompted to provide several signature samples, as indicated by the signature request message 345 shown on the image 300b in FIG. 3B. A signature count indicator 350 keeps track of how many signatures have been entered into a signature field 355. A signature registration prompt 365 consisting of a large letter X, a line on which to sign, and a “sign full name above” message instructs the enrollee where to sign. After completing a signature, the enrollee touches a “next” 340 button (soft key), which causes the signature count indicator 350 to increment and the signature field 355 to clear in preparation for a new signature entry. During the signature capture process, pressing a “cancel” button 330 cancels the enrollment process, whereas pressing a “back” button 335 clears the current signature and goes back to the previous signature, unless it is the first signature being displayed, in which case the display will return to the image 300a. The latter feature is useful if the enrollee enters a sloppy version of his or her signature and would like to redo it.

After all the signatures have been collected (preferably six or more), image 300c appears, which displays an enrollment success message 370, and an acknowledgment button 375 to close the enrollment session; otherwise the enrollment session will automatically close. If the enrollment is not successful, the image 300d displays an enrollment failure message 380, and if this enrollment failure is due to inconsistent signatures or a signature with too few discernible features (e.g., just a few letters followed by a horizontal line), a signature improvement message 385 is displayed along with an acknowledgment button 390, which when pressed will return the enrollee to image 300b, with the signature count indicator 350 indicating that the first signature is to be collected.

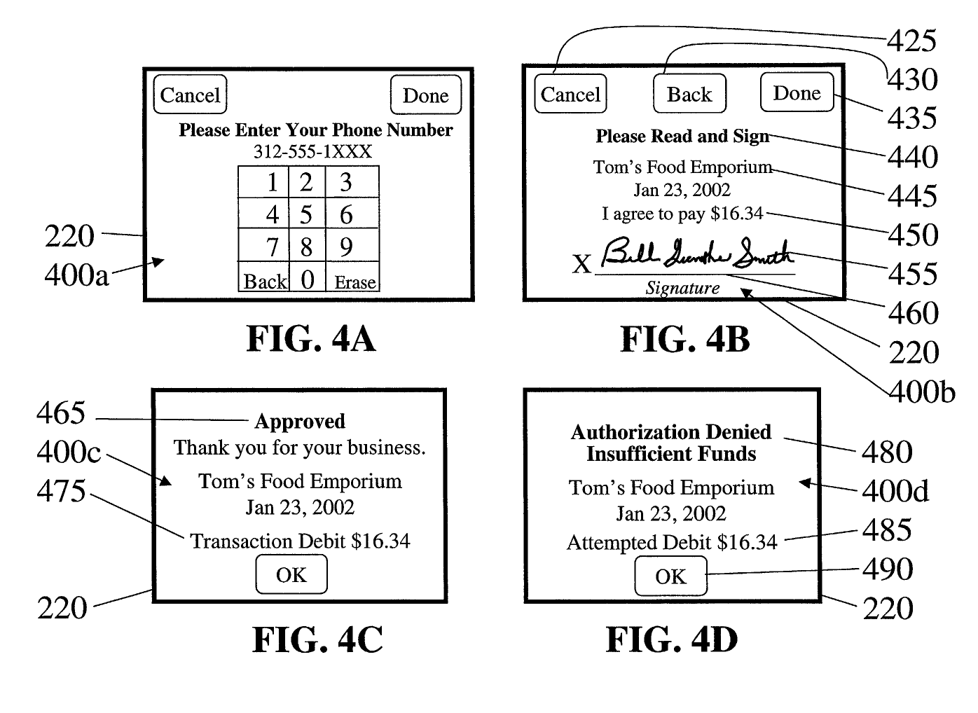

Once a person has successfully enrolled, he or she may execute transactions as illustrated by the various steps in the authorization process shown in FIGS. 4A, 4B, 4C, and 4D, which show images 400a, 400b, 400c, 400d, respectively; these images appear on the display 220 and preferably are stored in the controller 230. Image 400a is used to collect the phone number of the user (customer) at the time of the transaction, which is then used as an identifier. The customer interacts with the digitizer unit 200 in much the same way as during the enrollment procedure described above in connection with FIGS. 3A, 3B, 3C, and 3D. Image 400b prompts the user through a signature request message 440 to enter his or her signature 455 on a signature line 460. The entity declaration 445 reminds the customer with whom he or she is conducting business, and in the case of a financial transaction such as a retail purchase, an amount message 450 indicates how much money the customer is agreeing to pay to the stated entity, with this amount being received from the local computer 110, for example. Other buttons afford the customer additional options: a “cancel” button 425 cancels the transaction, a “back” button 430 goes back to the previously shown display, and a “done” button 435 submits the signature for verification.

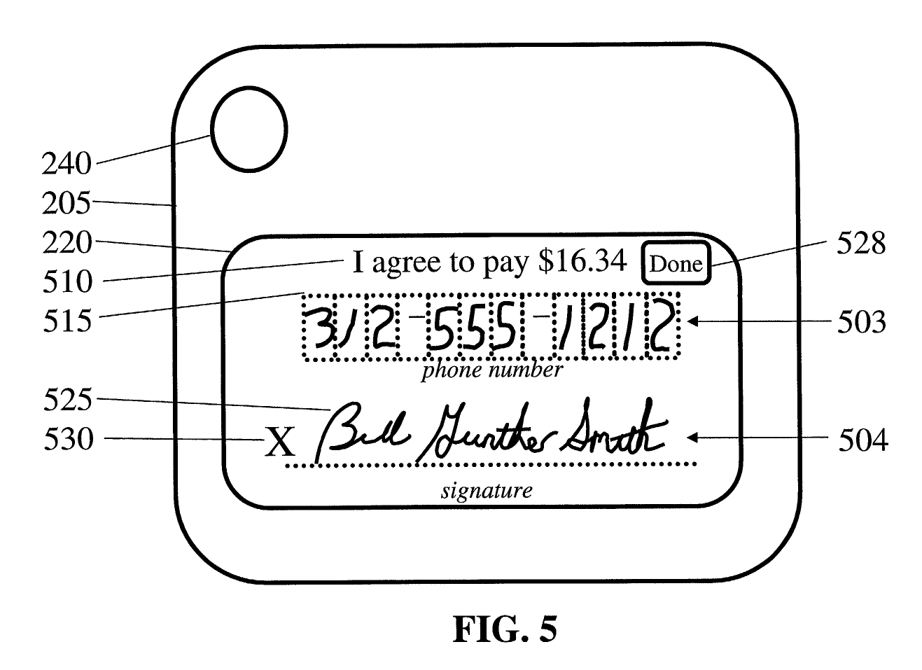

If the customer's signature is verified, the transaction is approved, and image 400c is displayed with its approval message 465 and transaction fulfillment message 475. Otherwise, image 400d is displayed with its authorization failure message 480 that may optionally include the reason for the failure, such as insufficient funds. If the authorization failure were due to a rejection of the signature (i.e., the signature did not match the reference signature that is associated with the enrolled phone number), image 400b would reappear after the customer presses an “OK” button 490, offering the customer a second chance to enter his or her signature. In a preferred implementation, three signature attempts are allowed after which the customer must reenter the identifying phone number. If the authorization failure were due to an invalid phone number (i.e., the entered phone number has not been enrolled in the authentication system 100), image 400a would appear after the person presses the OK button 490, offering the customer a second chance to enter his or her phone number. In this case filling out image 400b is necessary if the collected phone number and signature 455 are sent together (batch mode). If the authorization failure were due to insufficient funds, an attempted debit message 485 nevertheless reminds the customer how much he or she is trying to debit. (It might be useful for the purpose of conducting an abuse investigation to electronically store what name an unsuccessful customer was trying to use, offer, guess or forge.) FIG. 5 shows an alternative screen image for collecting both a phone number and a signature from a customer at the time a transaction is made. Thus, the single image shown in FIG. 5 advantageously combines the functions of images 300a and 300b shown in FIG. 3. Referring to FIG. 5, the display 220 of the digitizer unit 200 presents an identification field 503 and a verification field 504 that are located below a field 510 that indicates the amount to be paid. The identification field 503 may include boxes 515 that initially appear blank and then are filled in by the customer. The customer writes one digit of his or her identifier phone number in each box, thereby facilitating character recognition, e.g., when the information written by the user is sent to a processor for analysis. The dash characters (“-”) help delimit the full phone number format as used in North America. Other formats can be used to accommodate the phone numbering system of a particular country. Alternatively, if the customer's name is used as the identifier, the identification field 503 may be constructed accordingly. A signature registration prompt 530 prompts the customer to write his or her signature 525 in the signature field 504, after which the customer taps a “DONE” button 528. In an alternate implementation, the phone number entry is automatically assumed complete by the local computer 110 when an entry has been made in each of the boxes 515, eliminating the need for a “DONE” button 528.

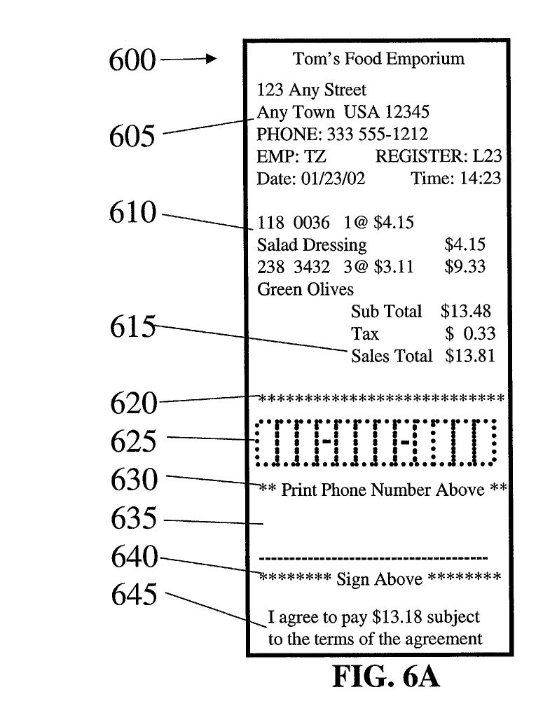

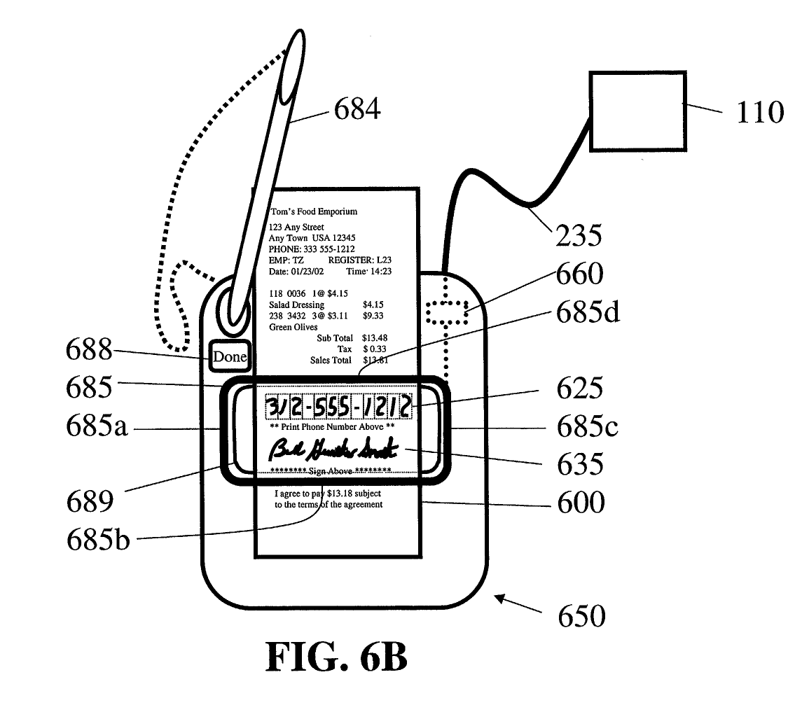

FIG. 6A shows a paper receipt 600 similar to one that a customer might ordinarily receive in a grocery store, for example. The receipt 600 contains information 605 related to the store, itemized sales information 610, and a sales total 615. In addition, an identification field 625 and a verification field 635 are also shown. A phone number prompt 630 and the alignment boxes in the field 625 help the customer print his or her phone number in the identification field. Likewise, the signature prompt 640 (appearing just below the verification field 635 and above a total amount message 645) shows the customer where he or she should sign.

Referring to FIG. 6B, the paper receipt 600 is used with a digitization unit 650 like the unit 200 shown in FIG. 2, except that the LCD display 220 of unit 200 is not needed since the paper receipt 600 serves as the display. The unit 650 does, however, include a digitization surface 689. The surface 689 sends a signal to a microcontroller 660 in the unit 650 in which the signal is given by the position of the tip of a pen 684 on the surface 689 (more precisely, the force exerted by the pen is transmitted through the receipt 600 and onto the surface 689). The microcontroller 660 receives this position information and transmits it through the data link 235 to the local computer 110. Further details regarding operation of a digital pad can be found in U.S. Pat. No. 5,943,044 to Martinelli et al. titled “Force sensing semiconductive touchpad”.

As shown in FIG. 6B, the strip of paper from which the receipt 600 is formed is first inserted into the digitization unit 650. In particular, the paper strip is passed underneath a registration guide 685 that is attached to the digitization unit 650. As shown in FIG. 6B, the registration guide 685 may be advantageously mounted to one side 685a of the digitizing station, with the remaining sides 685b, 685c, 685d being left open. With this arrangement, the paper receipt 600 can be slipped underneath the open side 685c and passed through the top side 685d and bottom side 685c. A receipt registration line 620 (see FIG. 6A) is aligned with the side 685d, so that the identification field 625 and the verification field 635 of the receipt 600 are aligned directly above portions of the surface 689 dedicated to receive identification and verification information, respectively, with this information being communicated to the microcontroller 660 (and onto the local computer 110 over the data link 235) by coordinate signals produced by the tip of the pen 684 coming into contact with the surface 689 (through the receipt 600). Thus, handwriting on the upper portion of the surface 689 is collected and interpreted by the local computer 110 as identification input, and handwriting on the lower portion of the surface 689 is collected and interpreted by the computer 110 as verification input. In this way, when the customer writes on the receipt 600, his or her writing actions are recorded not just on the paper receipt 600 but also by the surface 689 situated directly underneath the receipt. Note that the line 620 is not visible in FIG. 6B, as it is hidden behind the side 685d of the registration guide 685. After the customer has entered his or her identification and verification information, he or she taps a “DONE” button 688 to indicate completion of these tasks. In an alternate implementation, when a sufficient number of characters are received by the local computer 110 (e.g., 10 for a US phone number including area code), the local computer 110 concludes that the identification entry is complete.

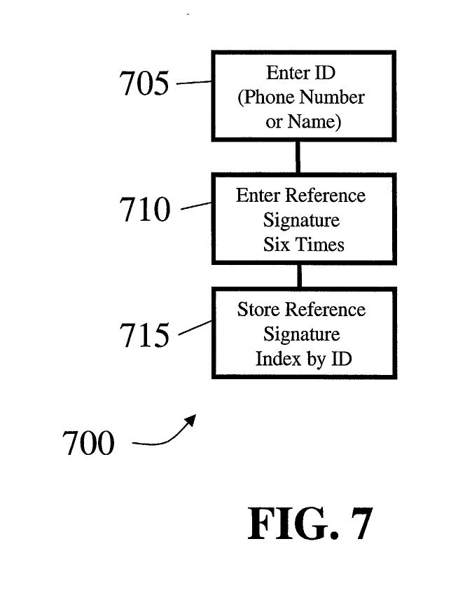

FIG. 7 is a flow chart 700 illustrating steps in an preferred enrollment process. In step 705, an identifier from the customer-to-be is collected, e.g., a phone number and/or name. In step 710 reference signatures are collected. More then one is desired since there tends to be natural variability in handwriting. Empirically it has been determined that six samples are generally sufficient to characterize a signature well enough to give good matching performance. In step 715 the reference signatures are stored in a database indexed (addressed) by the identification information or some calculation or manipulation based on the identification information.

If more than one signature is collected, it is advantageous to store all of them in the database 120. The written identification provided by the customer during enrollment may also be stored and used later by a character recognition method during the identification process to assist in retrieving the reference signature set. By limiting the identification to a small lexicon (vocabulary), the accuracy of handwriting is greatly improved, as taught for example in U.S. Pat. No. 6,401,067 to Lewis et al. titled “System and method for providing user-directed constraints for handwriting recognition” and U.S. Pat. No. 5,636,291 to Bellegarda et al. titled “Continuous parameter hidden Markov model approach to automatic handwriting recognition”. In a preferred implementation, a phone number is used as the tokenless identification, and the lexicon consists of the digits 0 to 9. In alternative implementations, other tokenless identifiers may be used. Since the security resides principally in the verification of the signature, the tokenless identifier can be, for example, any government issued identifier number, such as a social security number, driver's license number, passport number, green card number, or military ID number (which may include non-numeric characters such as letters).

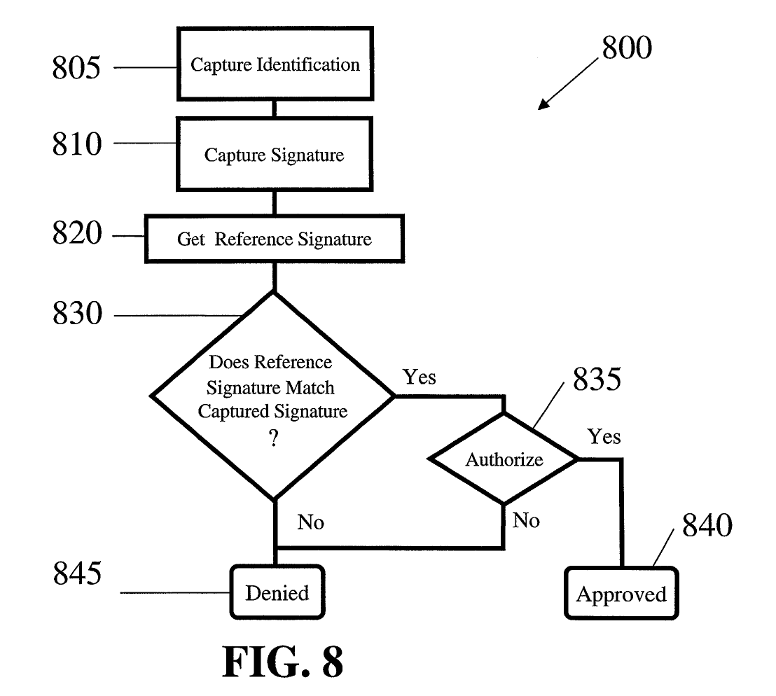

FIG. 8 is a flow chart that shows steps in a preferred authorization system 800 in accordance with a preferred implementation of the invention. In step 805 a tokenless identification is collected from the person wishing to be authenticated (e.g., from a customer desiring to make a purchase at a store). If the tokenless identification is handwritten, an on-line handwriting recognition means is used to convert the written characters into their respective characters, and these characters are formed into an address to index the biometric database 120.

In a preferred implementation of step 805, a person prints his or her phone number (or name, if the name is used as the identifier) onto a digitizer unit, and in so doing produces a sequence of pen tip positions that are converted into a corresponding string of ASCII characters representing the printed characters, which are then sent electronically from the local computer 110 to the remote server 115. This conversion process may include an on-line character recognition method such as the one taught in U.S. Pat. No. 5,636,291 to Bellegarda et al. titled “Continuous parameter hidden Markov model approach to automatic handwriting recognition”. As discussed previously, a phone number is a preferred tokenless identifier, since a phone number has a much smaller lexicon than does a name (ten vs. twenty six characters), and also, there is typically less variation in the writing styles of numbers than those of letters. In addition, a phone number is more likely to come closer to being a unique identifier than a name (especially for common names). The phone number's ten digits are then used as the index to the biometric database 120.

In an alternative implementation of the invention, the customer's phone number is entered electronically using a keypad (e.g., soft or mechanical), with the electronic input then being assembled into an address. The resulting sequence of alphanumerics, typically represented by ASCII characters, creates a character string that is converted to a multi-digit number. Whereas a phone number typically produces a 10 digit number that can be directly used as an index, a name produces a much larger number, since a full name could have several dozen characters. (A preferred method of indexing a database using a name is taught by U.S. Pat. No. 5,557,794 to Matsunaga et al. titled “Data management system for a personal data base”.)

In step 810 a signature sample to be verified is captured from the customer using a handwriting digitizer (e.g., like those shown in FIGS. 2, 5, and 6B), and sent electronically from the local computer 110 to the remote server 115. In step 820 the database address created by the customer's inputted identifier is used to retrieve the reference signature (or set of signatures as done in the preferred implementation) from the biometric database 120. In step 830 the signature to be verified is compared with the reference signature(s) using a handwriting matching method. A preferred verification method uses dynamic signature analysis including statistical and neural network means for making this comparison, as taught in co-pending application Ser. No. 09/295944 to Finkelstein titled “On line signature verification” and filed Apr. 21, 1999, which is hereby incorporated by reference. (Other methods of handwriting recognition are taught in U.S. Pat. No. 5,054,088 to Gunderson et al. titled “Signature verification data compression for storage on an identification card”; U.S. Pat. No. 5,226,091 to Howell et al. titled “Method and apparatus for capturing information in drawing or writing”; U.S. Pat. No. 3,818,443 to Radcliffe, Jr. titled “Signature verification by zero-crossing characterization”; U.S. Pat. No. 4,553,259 to Chainer et al. titled “Semi-independent shifting technique for signature verification”; U.S. Pat. No. 4,581,482 to Rothfjell titled “Method and device for signature verification”; U.S. Pat. No. 5,828,772 to Kashi et al. titled “Method and apparatus for parametric signature verification using global features and stroke-direction codes”; and U.S. Pat. No. 5,730,468 to Wirtz titled “Method for the dynamic verification of an autograph character string on the basis of a reference autograph character string”.) If the signature to be verified and the reference signature are not sufficiently similar, authorization is denied (step 845). If they are sufficiently similar, however, and an authorization condition (if one is used, step 835) is met, authorization is approved (step 840).

The authorization step 835 may be included, since in a financial transaction it is often not sufficient to be identified and verified. The authorization step 835 may include checking the balance and credit limit of the customer's account, looking for anomalies in purchasing patterns, or checking to see if the terms of an agreement have been met or breached. The conditions of authorization step 835 may vary among individuals, retail, and financial organizations. For example, an individual who has been a member of a credit plan for a long time may enjoy more lenient authorization rules, whereas the owner of a new account might be subject to more stringent requirements. Business rules that determine the authorization step 835 may reside in the organization that does the verification (step 830). The authorization step 835 may be executed before the verification step 820, thereby eliminating the need to execute the verification step 820 for those who do not meet the authorization requirements of step 835.

The thresholds and tests used in step 830 to determine if the signature collected at the time of the transaction is sufficiently similar to the reference signature may also vary with time, individual, transaction amount, store, and other variables. For example, transactions having low commercial value may have a lower match threshold associated with them, thereby resulting in an increase in false accepts and a decrease in false rejects. Long time members may also enjoy a lower match threshold. (The use of thresholds in handwriting verification is taught in U.S. Pat. No. 4,736,445 to Gundersen titled “Measure of distinguishability for signature verification”.) The dynamic verification method may also evolve over time to accommodate changes in a person's writing, printing, or signing style. For example, each time a signature is verified, the sample is added to the person's biometric database set, enabling the dynamic verification method to adapt to changes in handwriting style over time.

The reference signature database 120 may contain the reference signatures of more than one person having the same tokenless identification, e.g., several family members or roommates who share a phone number. In a preferred implementation of the invention, the biometric database 120 includes an extended address field that indicates the number of people who share the same phone number at the time of enrollment. Thus, the extended address field value could be set to 0 for a person who enrolls with a phone number that had not been previously entered in the database 120, but set to 1 for a person who enrolls with a phone number that has been previously associated with one enrollee, and set to 2 for a person who enrolls with a phone number that was previously associated with two enrollees, and so on. With this method, the combination of identifier and extended address field creates a unique address and means of distinguishing people who share the same tokenless identifier.

Authorization requirements may also vary with individual members who share the same identification. For example, a family of two adults and four children share the same phone number, and the children may spend up to $5 per day at a fast food restaurant while the parents may spend up to $100 per day at the same restaurant. This prevents the children from taking out their friends, while allowing them to order their own meal daily, but still allows the parents to pay for the entire family's meal.

To verify and then authenticate a person who shares a tokenless identifier with others, step 820 involves retrieving all the reference signatures (or sets of signatures) from the biometric database 120 that share that tokenless identifier. In step 830, the signature to be verified is compared with the reference signature(s) using a handwriting matching method, and the best match is selected. If the match meets or exceeds the similarity threshold determined by the policy of the application, the extended address field value for the selected reference signature is appended to the identifier to create a unique identifier, and the unique identifier is passed to step 830 for authorization. Otherwise the person is denied authorization for failing to produce a signature that sufficiently well matches any of the reference signatures indexed to the input identifier (step 805).

The methods taught herein can be implemented using software running on computational devices like the ones described herein, including personal computers, servers, microprocessors, gate arrays, microcontrollers, application specific integrated circuits, neural networks, and other processing means.

In preferred embodiments of the invention, there is provided media encoded with executable program code to effect any of the methods described herein. This code contains executable instructions that may reside, for example, in the random access memory (RAM) of a processor, or on a hard drive or optical drive of a processor. The instructions may be stored on a magnetic or optical disk or diskette, a disk drive, magnetic tape, read-only memory (static, dynamic or electronic), or other appropriate data storage device. In preferred embodiments, this program code may be read by a digital processing apparatus such as a processor or computer for performing any one or more of the methods disclosed herein.

The invention may be embodied in other specific forms without departing from its spirit or essential characteristics. The described embodiments are to be considered in all respects only as illustrative and not restrictive. The scope of the invention is therefore indicated by the appended claims rather than the foregoing description. All changes within the meaning and range of equivalency of the claims are to be embraced within that scope.

What is claimed is:

1. A method of verifying an individual's signature, comprising:
electronically capturing an individual's signature at the time of verification; and
electronically capturing from the individual at the time of verification a written identifier other than the individual's signature, the written identifier serving to identify the individual, so that the individual's captured signature can be electronically compared with a previously collected signature that is stored in a database where the previously collected signature is indexed to the identifier, thereby verifying that said individual is the same person from whom the stored signature was previously collected.

2. The method of claim 1, wherein payment for a purchase is authorized as a result of said electronically comparing.

3. The method of claim 1, wherein payment is authorized only if the amount of the payment is less than a predetermined limit.

4. The method of claim 1, wherein the written identifier is a phone number known to the individual.

5. The method of claim 1, wherein the written identifier is a name of the individual.

6. The method of claim 1, comprising performing character recognition of the written identifier.

7. The method of claim 1, said capturing of the signature comprising dynamic handwriting sampling.

8. A method of verifying an individual's signature, comprising:
capturing the individual's signature electronically at the time of verification; and
receiving, at the time of verification, input from the individual corresponding to his or her phone number, so that the individual's captured signature can be electronically verified by comparing it against a pre-collected signature that is stored in a database where the pre-collected signature is indexed to the phone number.

9. The method of claim 8, wherein payment for a purchase is authorized as a result of said comparing.

10. The method of claim 8, wherein payment is authorized only if the amount of the payment is less than a predetermined limit.

11. The method of claim 8, wherein said input is written input.

12. The method of claim 11, comprising performing character recognition of the written input.

13. The method of claim 8, wherein said input is entered using keys.

14. The method of claim 8, said capturing of the signature comprising dynamic handwriting sampling.

15. A method of verifying an individual's signature, comprising:
capturing the individual's signature electronically at the time of verification; and
receiving, at the time of verification, input from the individual corresponding to one of his or her government issued identification numbers, so that the individual's captured signature can be electronically verified by comparing it against a pre-collected signature that is stored in a database where the pre-collected signature is indexed to said one identification number.

16. The method of claim 15, wherein said one government issued identification number is selected from the group consisting of a social security number, driver's license number, passport number, green card number, or military ID number.

17. A method of verifying an individual's signature, comprising:
receiving an electronically captured signature provided by the individual at the time of verification;
receiving at the time of verification an electronically captured identifier other than the individual's signature, wherein the identifier serves to identify the individual and has been provided by the individual as written input at the time of verification;
identifying at least one person in a database by matching said individual's captured written identifier with an identifier in the database, wherein the database identifier has been previously entered into the database and is associated with said at least one person;
electronically retrieving from the database, for each of said at least one identified person, a signature of said at least one person that has been previously collected and entered into the database; and
electronically comparing the individual's captured signature with the retrieved signature to verify that said individual is the same person from whom the retrieved signature was previously collected.

18. The method of claim 17, wherein payment for a purchase is authorized as a result of said electronically comparing.

19. The method of claim 17, wherein payment is authorized only if the amount of the payment is less than a predetermined limit.

20. The method of claim 17, wherein the written input is a phone number known to the individual.

21. The method of claim 17, wherein the written input is a name of the individual.

22 The method of claim 17, comprising performing character recognition of the written input.

23. The method of claim 17, said captured signature including dynamic handwriting information.

24. A method of verifying an individual's signature, comprising:
receiving an electronically captured signature provided by the individual at the time of verification;
receiving, at the time of verification, input from the individual corresponding to his or her phone number;
identifying one or more persons in a database by matching the individual's phone number with a phone number in the database;
electronically retrieving from the database, for each of said one or more persons, a pre-collected signature; and
electronically verifying the individual's signature by comparing it against the retrieved signature.

25. The method of claim 24, wherein payment for a purchase is authorized as a result of said electronically comparing.

26. The method of claim 24, wherein payment is authorized only if the amount of the payment is less than a predetermined limit.

27. The method of claim 24, wherein said input is written input.

28. The method of claim 24, comprising performing character recognition of the written input.

29. The method of claim 24, wherein said input is entered using keys.

30. The method of claim 24, said captured signature including dynamic handwriting information.

31. A method of verifying an individual's signature, comprising:
receiving an electronically captured signature provided by the individual at the time of verification;
receiving, at the time of verification, input from the individual corresponding to one of his or her government issued identification numbers;
identifying one or more persons in a database by matching the identification number with an identification number in the database;
electronically retrieving from the database, for each of said one or more persons, a pre-collected signature; and
electronically verifying the individual's signature by comparing it against the retrieved signature.

32. The method of claim 31, said captured signature including dynamic handwriting information.

33. A computer program product comprising a computer usable medium for carrying out the method of claim 1.

34. A computer program product comprising a computer usable medium for carrying out the method of claim 17.

35. A digitizer unit, comprising:
an electronic component that includes a field designed for electronically capturing a signature and a field designed for electronically capturing written input (other than a signature) that identifies a user of the unit;
an electronic controller in electronic communication with said component; and
a housing for holding said controller and said display.

36. The unit of claim 35, wherein said written input is a phone number.

37. The unit of claim 35, wherein said written input is a name.

38. The unit of claim 35, said component including a display.

39. The unit of claim 35, said component including a position capture element.

40. A digitizer unit, comprising:
an electronic component that includes a field designed for electronically capturing a signature and a field designed for electronically capturing a phone number;
an electronic controller in electronic communication with said component; and
a housing for holding said controller and said display.

41. A digitizer unit, comprising:
an electronic component that includes a field designed for electronically capturing a signature and a field designed for electronically capturing a government issued identification number;
an electronic controller in electronic communication with said component; and
a housing for holding said controller and said display.
